(19) United States
(12) Patent Application Publication
(10) Pub. No.: US 2025/0278548 A1
(43) Pub. Date: Sep. 4, 2025

(54) Method and Apparatus for Co-Browsing Adopted Stylesheets

(71) Applicant: Glance Networks, Inc., Wakefield, MA (US)

(72) Inventors: Brendan Ronan, Watertown, MA (US); Deborah Méndez, Arlington, MA (US)

(21) Appl. No.: 19/014,303

(22) Filed: Jan. 9, 2025

Related U.S. Application Data
(60) Provisional application No. 63/560,937, filed on Mar. 4, 2024.

(51) Int. Cl. G06F 40/154

(52) U.S. Cl. CPC G06F 40/154

(57) ABSTRACT

Co-browsing webpages containing regions with adopted stylesheets is enabled between a visitor and agent, while minimizing transmission of CSS associated with adopted stylesheets on the co-browsing session. When the visitor encounters an adopted stylesheet, the visitor creates a StyleID from the CSS of the adopted stylesheet, and transmits the StyleID on the co-browse session instead of the CSS. When the agent receives the StyleID, the agent determines if it has a locally stored copy of the CSS corresponding to the StyleID. In instances where the agent has the locally stored copy, the agent applies the corresponding CSS to the region. In instances where the agent doesn't have a locally stored copy, the agent requests a copy of the CSS from a UCAM facilitating the co-browse session. The UCAM stores CSS corresponding to StyleIDs for use between multiple co-browse sessions and requests unknown StyleID CSS from the visitor.

### CROSS REFERENCE TO RELATED APPLICATIONS

This application claims priority to U.S. Provisional Patent Application No. 63/560,937, filed Mar. 4, 2024, the content of which is hereby incorporated herein.

### COPYRIGHT NOTICE

A portion of the disclosure of this patent document contains material which is subject to copyright protection. The copyright owner has no objection to the xerographic reproduction by anyone of the patent document or the patent disclosure in exactly the form it appears in the Patent and Trademark Office patent file or records, but otherwise reserves all copyright rights whatsoever.

### FIELD

The field relates to communication sessions and, more particularly, to a method and apparatus for optimizing co-browsing of webpages containing shadow DOM regions with adopted stylesheets.

### SUMMARY

It is possible for the content of a first browser to be shared and reproduced in a second browser at a geographically remote location. One way to do this is to cause the Document Object Model (DOM) describing the content of the first browser to be forwarded to the second browser. The second browser uses the DOM received from the first browser to recreate the content of the first browser. Implementing DOM sharing between a pair of computers is referred to herein as co-browsing.

The Document Object Model (DOM) of an XML or HTML document is a tree-like structure, wherein each DOM element is an object representing a part of the document. It is possible to create a scoped area within the DOM that has DOM elements that are not visible to the rest of the tree. Such DOM elements are referred to herein as “shadow DOM elements”, and the regions of the DOM that contains the shadow DOM elements are referred to herein as a “shadow DOM regions”. Global attributes do not apply to shadow DOM elements in a shadow DOM region, which enables portions of DOM to be reused without consideration of how the other attributes of the DOM will affect the shadow DOM elements of the shadow DOM regions. Shadow DOM regions may be nested, such that there can be inner shadow DOM regions inside a given shadow DOM region, and the nesting may occur to any desired level.

Stylesheets are used to format the layout of a webpage. For example, Cascading Style Sheets (CSS) declarations make it possible to control the color, the font, the size of the text, and many other aspects of how the website looks. Constructed stylesheets are created programmatically, and provide a way to set an array of constructed stylesheets to be used by the document. Constructed stylesheets can be shared with one or more shadow root instances. For example, the adoptedStyleSheets property of the ShadowRoot interface can be used to set an array of constructed stylesheets to be used by the shadow DOM subtree.

When a webpage with adopted stylesheets is co-browsed, transmission of the stylesheets from the visitor to the agent can cause performance issues on both sides of the co-browse session. Specifically, on a page with large amounts of adopted stylesheets, the transmission of the shadow DOM elements from the visitor to the agent can consume significant resources.

According to some embodiments, a method and apparatus for optimizing co-browsing of webpages containing shadow DOM regions with adopted stylesheets is provided. In some embodiments, when a visitor on a co-browse session transmits the visitor DOM, any time there is an adopted stylesheet attached to a shadow DOM element, the visitor transmits a StyleID rather than the actual CSS of the adopted stylesheet. In some embodiments, the StyleID is created from a hash of the CSS contained in the adopted stylesheet. Transmitting the StyleID rather than the actual CSS saves considerable bandwidth at the visitor, since the visitor only needs to send the hash of the CSS which is used as the identifier of the CSS, rather than the actual content of the CSS.

When the agent receives a message associating a StyleID with a shadowDOM element, the agent checks to determine if the agent has already received the CSS associated with the StyleID. In instances where the agent has the CSS locally stored, the agent applies the CSS to the DOM element. In instances where the agent does not have the CSS associated with the StyleID locally stored, the agent transmits the StyleID to the UCAM to request a copy of the CSS associated with the StyleID from the UCAM.

When the UCAM receives a request for the CSS of an adopted stylesheet identified by the StyleID, it determines whether it has a locally stored copy of the adopted stylesheet in its CSS data store. In instances where the UCAM has a locally stored copy of the adopted stylesheet in its CSS data store, the UCAM responds directly to the agent with the requested CSS. In response to a determination that the UCAM does not have a locally stored copy of the adopted stylesheet CSS, the UCAM sends a constructed stylesheet request to the visitor.

The visitor co-browse JavaScript receives the constructed stylesheet request message with the StyleID identifying one of the adopted stylesheets that the visitor co-browse JavaScript has detected as being attached to one of the shadow root elements of the DOM. The visitor co-browse JavaScript checks its shadow DOM state for that StyleID and uploads the CSS associated with the StyleID to the UCAM using a resource upload message.

The UCAM locally stores the CSS that it receives from the visitor in the CSS data store and the UCAM then returns the adopted stylesheet to the agent. Subsequent requests for the adopted stylesheet from the agent or from other agents on other co-browse sessions are then able to be served directly from the UCAM service by accessing the CSS contained in the CSS data store.

By optimizing the manner in which the stylesheets are handled, it is possible to dramatically reduce the number of constructed stylesheets that must be transmitted by the visitor on the co-browse session, thus reducing the impact on visitor side performance. Agent side performance is improved, as constructed stylesheets can be retrieved from the local browser cache or server side cache, without having to wait for a visitor upload. By enabling reuse of the adopted CSS by the UCAM, it is possible for adopted stylesheets to be reused within a given session, reused on different sessions, and reused with different pages and agents. Since a given website might be accessed by numerous visitors and agents and co-browse sessions for the given website typically include identical adopted stylesheets, enabling the UCAM to reuse adopted stylesheets across co-browse sessions can result in a significant reduction of resource usage at the visitor. Further, by having the visitor and agent refer to the adopted stylesheets using a StyleID such as a hash value created from the CSS, rather than repeatedly transmitting the CSS of the adopted stylesheet, it is possible to reduce the latency for the agent, by enabling the agent to load stylesheets from local browser cache or server side cache, as compared to the latency associated with requiring the agent to wait for the stylesheets to be uploaded from the visitor, thus improving performance of both the agent and the visitor.

In some embodiments, a method for optimizing co-browsing of webpages containing shadow DOM regions with adopted stylesheets, includes establishing a co-browse session between a first participant computer and a second participant computer in which a Document Object Model (DOM) of a first browser at the first participant computer is transmitted to the second participant computer, and used at the second participant computer to recreate a content of the first browser at a second browser, the DOM including a plurality of DOM elements, identifying a DOM element by the first participant computer that has an adopted stylesheet, the adopted stylesheet including a corresponding set of Cascading Style Sheets (CSS) content, and creating a StyleID to uniquely identify the complete set of CSS content corresponding to the adopted stylesheet. The method further includes forwarding the DOM element and the StyleID on the co-browse session by the first participant computer, without forwarding the set of CSS content corresponding to the adopted stylesheet, receiving a request, by the first participant computer, for the set of CSS content, and only in response to receiving the request for the set of CSS content, transmitting by the first participant computer the set of CSS content on the co-browse session.

In some embodiments, creating the StyleID by the first participant computer comprises applying a hash function to the complete set of the CSS parameters corresponding to the adopted stylesheet.

In some embodiments, the method further includes storing the StyleID and the set CSS content by the first participant computer.

In some embodiments, after transmitting, by the first participant computer, the set of one or more CSS content, the method further includes storing the StyleID and the set of CSS content by a server facilitating the co-browse session. In some embodiments, the server facilitating the co-browse session is configured to respond to requests for sets of CSS content corresponding to StyleIDs sent by the second participant computer. In some embodiments, the server facilitating the co-browse session is configured to store StyleID and corresponding CSS from multiple co-browse sessions and respond to requests for sets of CSS content corresponding to StyleIDs from the second participant computer on the co-browse session that were learned on the multiple co-browse sessions.

In some embodiments, the method further includes storing the StyleID and the set of CSS content by the second participant computer. In some embodiments, the method further includes receiving the StyleID by the second participant computer on the co-browse session, determining by the second participant computer that the set of CSS content corresponding to the StyleID is known by the second participant computer, and locally applying the CSS content to the DOM element by the second participant computer without requesting transmission of the corresponding set of CSS content on the co-browse session.

### BRIEF DESCRIPTION OF THE DRAWINGS

FIG. 1 is a functional block diagram of a network of components for implementing a co-browse session, according to some embodiments.

FIG. 2 is a functional block diagram of an example DOM describing a hypothetical web page that may be loaded to a browser such as the visitor browser of FIG. 1.

FIG. 3 is a flowchart of an example method of co-browsing adopted stylesheets showing actions taken by a visitor on the co-browse session, according to some embodiments.

FIG. 4 is a flowchart of an example method of co-browsing adopted stylesheets showing actions taken by an agent on the co-browse session, according to some embodiments.

FIG. 5 is a flowchart of an example method of co-browsing adopted stylesheets showing actions taken by a Universal Co-browse Asset Management (UCAM) process on the co-browse session, according to some embodiments.

FIG. 6 is a flowchart of an example method of co-browsing adopted stylesheets showing interactions between the visitor, UCAM, and Agent, according to some embodiments.

FIGS. 7-12 are diagrams showing interaction between the network of components of FIG. 1 to optimize the manner in which adopted stylesheets are handled on co-browse session and between co-browse sessions, according to some embodiments.

### DETAILED DESCRIPTION

The following detailed description sets forth numerous specific details to provide a thorough understanding of one or more embodiments of the invention. However, those skilled in the art will appreciate that the invention may be practiced without these specific details. In other instances, well-known methods, procedures, components, protocols, algorithms, and circuits have not been described in detail so as not to obscure the invention.

Some aspects, features and implementations described herein may include machines such as computers, electronic components, optical components, and processes such as computer-implemented procedures and steps. It will be apparent to those of ordinary skill in the art that the computer-implemented procedures and steps may be stored as computer-executable instructions on a non-transitory tangible computer-readable medium. Furthermore, it will be understood by those of ordinary skill in the art that the computer-executable instructions may be executed on a variety of tangible processor devices, i.e., physical hardware. For ease of exposition, not every step, device or component that may be part of a computer or data storage system is described herein. Those of ordinary skill in the art will recognize such steps, devices and components in view of the teachings of the present disclosure and the knowledge generally available to those of ordinary skill in the art. The corresponding machines and processes are therefore enabled and within the scope of the disclosure.

The terminology used in this disclosure is intended to be interpreted broadly within the limits of subject matter eligibility. The term “logic” is used to refer to special purpose physical circuit elements, firmware, and/or software implemented by computer instructions that are stored on a non-transitory tangible computer-readable medium and implemented by multi-purpose tangible processors, and any combinations thereof.

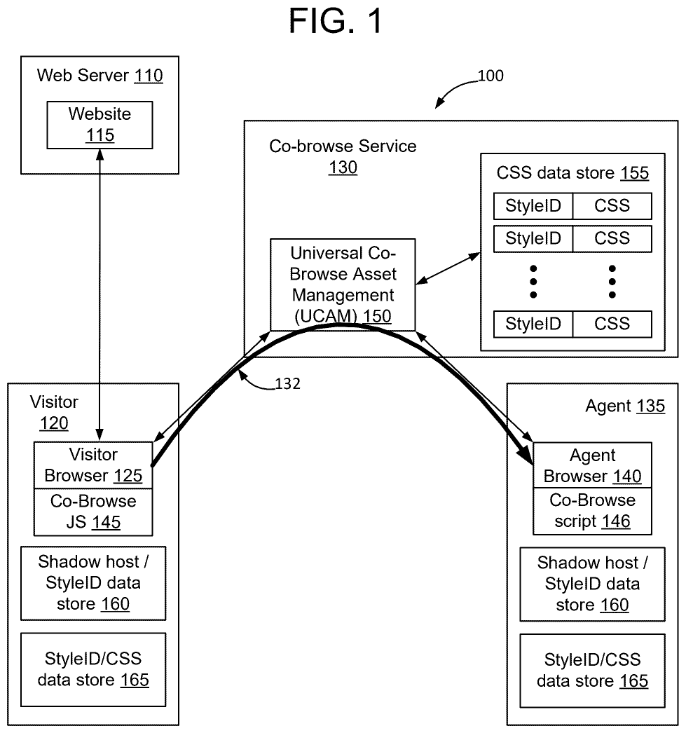

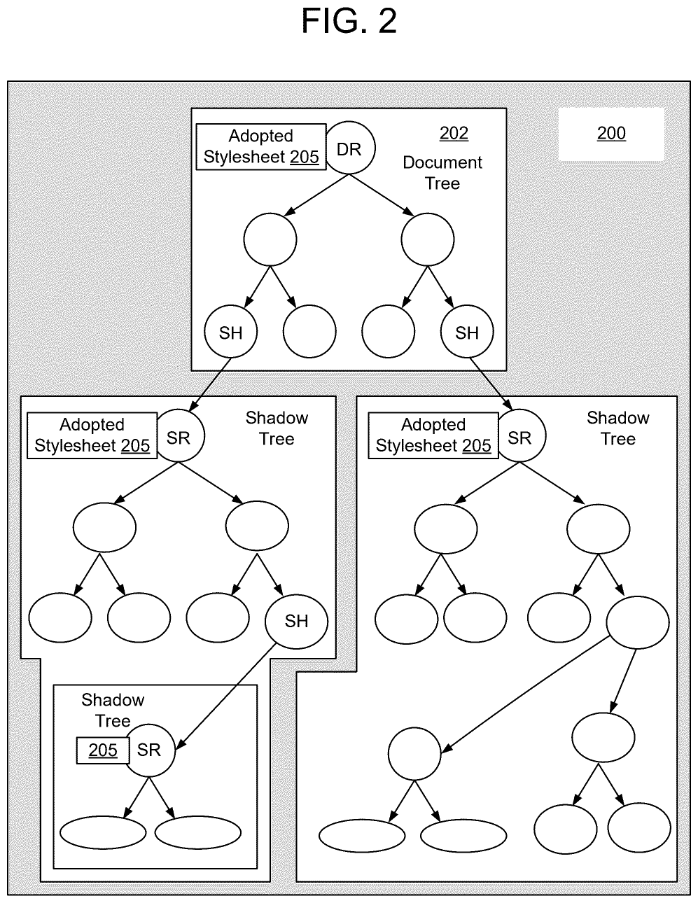

FIG. 1 is a functional block diagram of a network 100 of components for implementing a co-browse session 132, according to some embodiments. As shown in FIG. 1, in some embodiments a web server 110 hosts website 115. A visitor 120 accesses website 115 using visitor browser 125 to load web pages from the web server 110. The web page 120 is described by visitor DOM which, as described below, in some instances includes shadow DOM regions and optionally nested shadow DOM regions (see FIG. 2). A co-browse service 130 facilitates a co-browse session 132 on which an agent 135 is able to view the content of the visitor browser 125 in agent browser 140.

Throughout this description the term “visitor” will be used to refer to the computer that has a browser 125 acting as the source of content on a co-browse session 132. The term “visitor” is not intended to be limiting, as other terms such as “presenter” or “content source” could equally be used. Thus, the term “visitor” is used merely for convenience. Likewise, throughout this description the term “agent” will be used to refer to the computer that has a browser 140 acting as the recipient of the content on the co-browse session 132. The term “agent” is not intended to be limiting, as other terms such as “viewer” or “content recipient” could equally be used. Thus, the term “agent” is used merely for convenience. The terms “visitor” and “agent” are not intended to limit the scope of the disclosure to only apply to the use case where a visitor to a website opens a co-browse session to obtain assistance from an agent in a call center associated with the website, although that is one possible use of co-browse sessions.

In some embodiments, the web pages loaded from web server 110 are scripted with co-browse JavaScript 145. Alternatively, the co-browse JavaScript 145 may be loaded to visitor browser 125 as a plugin or extension. Co-browse JavaScript 145 causes the Document Object Model (DOM) describing the webpage loaded in visitor browser 125 to be forwarded to the co-browse service 130 on co-browse session 132. Co-browse service 130 forwards the DOM to the agent browser 140 on co-browse session 132 to enable the agent browser 140 to have a consistent view of the content of the visitor's browser 125. Additional details of how an example co-browse system of this nature may be implemented is provided in U.S. Pat. No. 9,736,214, entitled INTEGRATING CO-BROWSING WITH OTHER FORMS OF INFORMATION SHARING, the content of which is hereby incorporated herein by reference.

Some embodiments are described herein that refer to the use of shadow DOM. One example system for co-browsing Shadow DOM elements is described in U.S. Pat. No. 11,227,098, entitled METHOD AND APPARATUS FOR CO-BROWSING SHADOW DOM ELEMENTS, the content of which is hereby incorporated herein by reference. A resource acquisition process that is configured to acquire resources on behalf of the agent is described in U.S. Pat. No. 11,269,582, entitled METHOD AND APPARATUS FOR ACCESSING PROPRIETARY RESOURCES ON A CO-BROWSE SESSION, the content of which is hereby incorporated herein by reference.

FIG. 2 is a functional block diagram of an example DOM 200 describing a hypothetical web page that may be loaded to a browser such as the visitor browser 125 of FIG. 1. As shown in FIG. 2, in some embodiments the DOM 200 describing a web page includes a Document Root (DR) DOM element labeled element DR in FIG. 2, and a tree-like structure of DOM elements shown as circles and ovals in FIG. 2. In some instances, some elements of the DOM 200 are Shadow Host DOM elements, which are labeled SH in FIG. 2. Each Shadow Host SH DOM element references a Shadow Root SR of a shadow DOM region. Shadow Roots are labeled SR in FIG. 2. Shadow Roots are part of the DOM, but are not DOM elements, and as such are not assigned element ids and do not have assigned attributes.

The portion of the DOM tree 200 between the document root element DR and the first level of shadow host elements SH (SH-4 and SH-7) is referred to herein as the “top-level DOM”. The portion of the DOM tree 200 that sits below a shadow host element, and is hidden from the top-level DOM, is referred to herein as a shadow DOM region. Each shadow DOM region includes a shadow tree, which is a portion of the DOM that is hidden from the rest of the DOM. The shadow tree has a shadow root, labeled SR in FIG. 2, and possibly one or more DOM elements that sit below the shadow root SR in the shadow DOM region. DOM elements in the shadow DOM region can be shadow host elements SH, to thus enable shadow DOM regions to be nested to an arbitrary depth. In some embodiments, a shadow host element SH is an element in the DOM 200 for which the native attachShadow method has been called, thereby creating a shadow DOM region, which can be accessed via the element's shadowRoot attribute.

As shown in FIG. 2, in some embodiments adopted stylesheets 205 can be applied to shadow DOM regions. When the agent browser 140 receives the DOM describing the content of visitor browser 125, conventionally the agent browser 140 would request the resources described in the DOM, including the CSS associated with the adopted stylesheets, from the website 115. However, there are instances where the agent browser 140 will not be able to obtain the same resources from website 115 as visitor browser 125 is able to obtain from website 115. For example, in some instances the adopted stylesheets attached to shadow root elements within the visitor DOM will be unavailable to the agent via the website. Accordingly, conventionally these adopted stylesheets would be requested by the agent and forwarded from the visitor to the agent on the co-browse session 132, which can cause strain on both the visitor and the agent.

According to some embodiments, a co-browse service implements a Universal Co-browse Asset Management process 150 (UCAM) that is used to cache adopted stylesheets in a CSS data store 155 to enable the adopted stylesheets to be used within a session and between sessions while minimizing the amount of CSS that is required to be transmitted by visitors to the UCAM and minimizing the amount of CSS that is required to be transmitted by the UCAM to the agents. Similarly, in some embodiments the agent and the visitor also implement respective CSS data stores 165 to enable the agent and the visitor to keep track of CSS associated with particular adopted stylesheets.

In some embodiments, a co-browse service implements a Universal Co-browse Asset Management process 150 (UCAM) that is used to cache adopted stylesheets. When an adopted stylesheet is detected on the visitor's page, the visitor co-browse JavaScript 145 creates a unique ID by taking a hash of the whole set of CSS rules string. In some embodiments, the whole set of CSS rules string includes the Cascading Style Sheet (CSS) “content,” includes CSS declarations, directives, and comments. This unique ID (referred to herein as a “styleID”) is stored in a map of shadow host element id (sdid) to a list of styleIDs representing all stylesheets adopted by the element. In some embodiments, the map is implemented as a set of maps, in which a first map correlates shadow host element IDs, ssids, to styleIDs, and a second map correlates the styleIDs to CSS. The visitor then sends to the agent this new map of sdids to styleIDs. The visitor also rewrites the URLs in the Cascading StyleSheets (CSS) that are attached to the shadow root element (sdid) as adopted stylesheets, so that the URLs point to the UCAM server.

When the agent reconstructs the DOM, the agent fetches the CSS attached to the shadow root (adopted stylesheets) from the UCAM server. As noted, the URLs contained within the CSS were changed to point at the UCAM server, so when the agent is reconstructing the DOM the agent browser will request those resources from the UCAM server as well. Although some embodiments are described in which the agent requests the adopted stylesheets from the UCAM, it should be noted that the same process may be used to handle other forms of CSS, such as CSS attached to the DOM head such as when the CSS is applied to the document as a whole.

In some embodiments, when the visitor transmits the visitor DOM, any time there is an adopted stylesheet attached to a shadow DOM element, the visitor transmits the StyleID (hash value) rather than the actual CSS of the adopted stylesheet. This saves considerable bandwidth at the visitor, since the visitor only needs to send the hash of the CSS which is used as the identifier of the CSS, rather than the actual content of the CSS. Likewise, in some embodiments when the agent requests a copy of the CSS from the UCAM, the agent includes the StyleID (hash value) identifying the requested CSS from the UCAM.

When the UCAM receives a request for an adopted stylesheet, it determines whether it has a locally stored copy of the adopted stylesheet in its CSS data store 155. In instances where the UCAM has a locally stored copy of the adopted stylesheet in its CSS data store 155, the UCAM responds directly to the agent with the requested CSS. In response to a determination that the UCAM does not have a locally stored copy of the adopted stylesheet CSS, the UCAM sends a constructed stylesheet request to the visitor.

The visitor co-browse JavaScript 145 receives the constructed stylesheet request message with the StyleID identifying one of the adopted stylesheets that the visitor co-browse JavaScript 145 has detected as being attached to one of the shadow root elements of the DOM. The visitor co-browse JavaScript 145 checks its shadow DOM state for that stylesheet ID and uploads it to the UCAM using a resource upload message.

The UCAM locally stores the CSS that it receives from the visitor in the CSS data store 155 and the UCAM then returns the adopted stylesheet to the agent. Subsequent requests for the adopted stylesheet from the agent or from other agents on other co-browse sessions are then able to be served directly from the UCAM service by accessing the CSS contained in the CSS data store 155.

By optimizing the manner in which the stylesheets are handled, it is possible to dramatically reduce the number of constructed stylesheets that must be transmitted from the visitor on the co-browse session, thus improving the performance of the visitor. By enabling reuse of the adopted CSS by the UCAM, it is possible for adopted stylesheets to be reused within a given session, reused on different sessions, and reused with different pages and agents. Since a given website might be accessed by numerous clients and agents and co-browse sessions for the given website typically include identical adopted stylesheets, enabling the UCAM to reuse adopted stylesheets across co-browse sessions can result in a significant reduction of resource usage at the visitor. Further, by having the visitor and agent refer to the adopted stylesheets using a StyleID such as a hash value created from the CSS, rather than transmitting the CSS of the adopted stylesheet, it is possible to reduce the bandwidth required to implement the co-browse session thus improving performance of both the agent and the visitor.

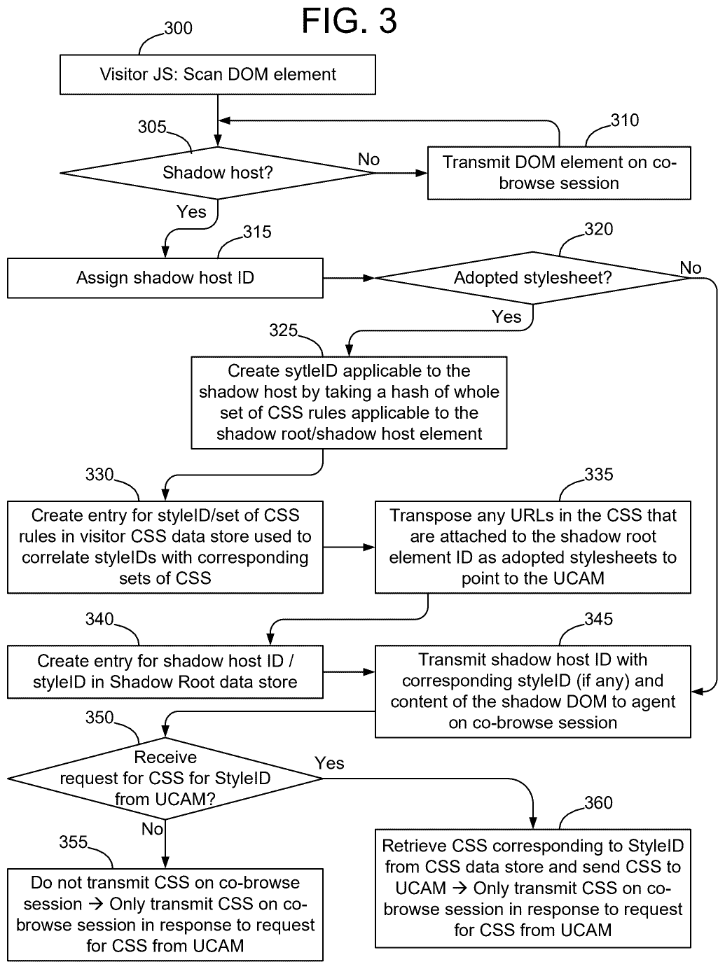

FIG. 3 is a flowchart of an example method of co-browsing adopted stylesheets showing actions taken by a visitor on the co-browse session, according to some embodiments. As shown in FIG. 3, in some embodiments the visitor co-browse JavaScript 145 scans the DOM looking for shadow DOM elements (block 300). When a DOM element is encountered, the visitor co-browse JavaScript 145 determines whether the element is a shadow host (block 305). In response to a determination that the DOM element is not a shadow host (a determination of NO at block 305), the visitor co-browse JavaScript 145 transmits the DOM element on the co-browse session (block 310).

In response to a determination that the DOM element is a shadow host (a determination of YES at block 305), the visitor co-browse JavaScript 145 assigns the shadow host a shadow host ID (block 315) and determines whether there are any adopted stylesheets associated with the shadow host (block 320). In response to a determination that the shadow host does not have any adopted stylesheets (a determination of NO at block 320), the visitor co-browse JavaScript 145 transmits the shadow host together with the content of the shadow DOM to the agent on the co-browse session (block 345).

In response to a determination that the shadow host does have an adopted stylesheet (a determination of YES at block 320), the visitor co-browse JavaScript 145 creates a StyleID applicable to the shadow host. In some embodiments, the styleID is created by the visitor co-browse JavaScript 145 by taking a hash of the entire set of CSS rules applicable to the shadow root associated with the shadow host element (block 325).

As noted above, in some embodiments the visitor co-browse JavaScript 145 is downloaded from the web server 110 in connection with loading web page 115 to the visitor's browser 125. Since the same visitor co-browse JavaScript 145 will be downloaded to multiple visitors, when those multiple visitors visit the same webpage 115, each instance of visitor co-browse JavaScript 145 will use the same hash function to create StyleIDs when encountering adopted stylesheets attached to shadow host elements. Accordingly, each instance of the visitor co-browse JavaScript 145 will create the same StyleID for a given shadow host element, whenever the instance of visitor co- browse JavaScript 145 encounters a shadow host element with the same CSS. As described in greater detail below, by enabling the UCAM to cache CSS associated with StyleIDs and reuse the cached CSS between co-browse sessions, only one instance of visitor co-browse JavaScript 145 will need to transmit the actual CSS associated with a given StyleID to the UCAM. All other visitors will only need to transmit the computed StyleID for a given shadow host element, thus greatly reducing the amount of CSS information required to be transmitted on a set of co-browse sessions related to different visitors that are co-browsing a given website 110.

As shown in FIG. 3, in some embodiments when a StyleID is created for an adopted stylesheet, the visitor co-browse JavaScript 145 creates an entry for the StyleID and stores the corresponding CSS along with the StyleID in a StyleID/CSS data store 165. In some embodiments, when storing the CSS, the visitor co-browse JavaScript 145 transposes any URLs in the CSS that are attached to the shadow host element ID as adopted stylesheets to point to the UCAM (block 335). In some embodiments, the StyleID/CSS content is stored as a key value pair in the CSS data store, in which the StyleID is the key and the set of CSS rules is the value. By storing the StyleID/CSS in the CSS data store, the visitor co-browse JavaScript 145 will be able to quickly obtain the CSS corresponding with a given StyleID in response to a request from the UCAM.

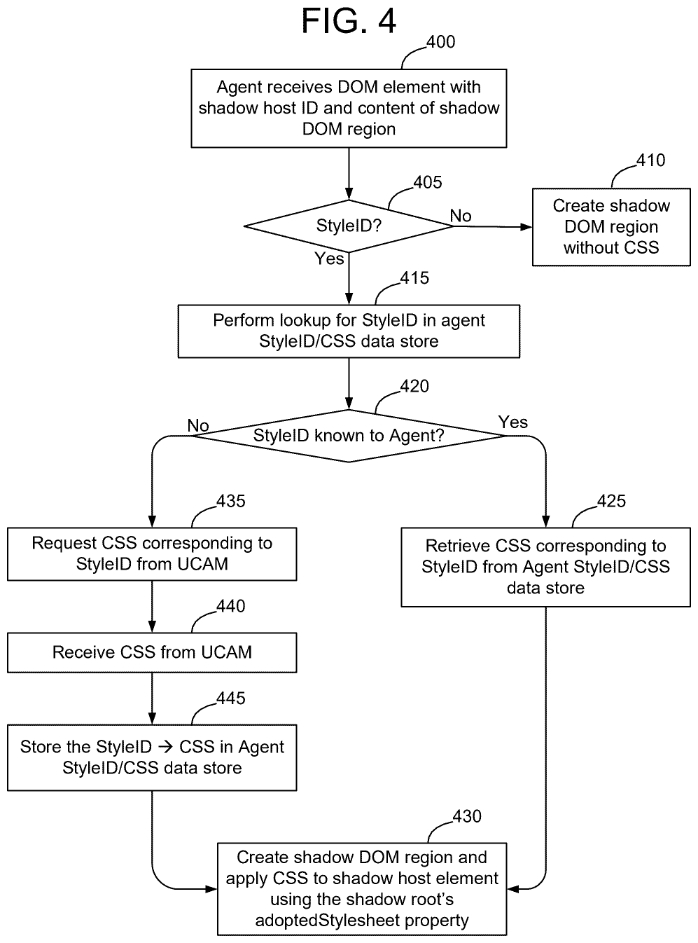

In some embodiments, the visitor co-browse JavaScript 145 also creates an entry for the shadow host ID and the corresponding StyleID, which is separately stored in a shadow root data store 160 (block 340). The visitor co-browse JavaScript 145 then transmits the shadow host element ID with the corresponding StyleID and the content of the shadow DOM to the agent on the co-browse session (block 345). As described in greater detail in connection with FIG. 4, when the agent receives the shadow host element ID and corresponding StyleID, the agent will attempt to obtain the CSS associated with the StyleID first from a local agent StyleID/CSS data store 165, which may be implemented in some embodiments using a combination of an in-memory data structure and an agent browser cache, and then from the UCAM. In instances where the UCAM does not have the CSS associated with a particular StyleID, the UCAM will send a request for the CSS corresponding to a particular StyleID to the visitor co-browse JavaScript 145.

Accordingly, as shown in FIG. 3, in some embodiments the visitor co-browse JavaScript 145 determines whether it has received a request for the CSS associated with a particular StyleID from the UCAM (block 350). In response to a determination that the visitor co-browse JavaScript 145 has not received a request for the CSS associated with a particular StyleID from the UCAM (a determination of NO at block 350), the visitor co-browse JavaScript 145 does not transmit the CSS on the co-browse session (block 355). In response to a determination that the visitor co-browse JavaScript 145 has received a request for the CSS associated with a particular styleID from the UCAM (a determination of YES at block 350), the visitor co-browse JavaScript 145 retrieves the CSS corresponding to the StyleID from the StyleID/CSS data store 165 and transmits the CSS to the UCAM on the co-browse session (block 360). In this manner, the visitor co-browse JavaScript 145 will only transmit CSS on a co-browse session in response to a request for the CSS from the UCAM. Further, the visitor co-browse JavaScript 145 will only transmit CSS associated with a particular StyleID when requested, and does not transmit all cached CSS/StyleID information to the UCAM. By minimizing the amount of CSS that is transmitted on the co-browse session, it is possible to greatly reduce the total amount of information that the visitor must transmit to the agent while still enabling the agent to apply the correct corresponding CSS to each of the shadow DOM regions.

FIG. 4 is a flowchart of an example method of co-browsing adopted stylesheets showing actions taken by an agent on the co-browse session, according to some embodiments. As shown in FIG. 4, in some embodiments when the agent receives a DOM element with a shadow root identifier, the agent determines the content of the shadow DOM (block 400) and checks to determine if there is a StyleID associated with the shadow root identifier (block 405). In response to a determination that the shadow DOM element does not have a corresponding StyleID (a determination of NO at block 405), the agent co-browse JavaScript creates the shadow DOM region from the shadow DOM content without CSS (block 410).

In response to a determination that the shadow DOM element does have a corresponding StyleID (a determination of YES at block 405), the agent co-browse JavaScript performs a lookup in the agent StyleID/CSS data store 165 (block 415) to determine if the StyleID is known to the agent co-browse JavaScript (block 420).

In some embodiments, the agent includes an in-memory data structure that is created by the agent co-browse JavaScript to keep a cache of the shadowDOM CSS. This data structure is lost when the visitor navigates to a new page, because the agent's view that contains the data structures is swapped out. In some embodiments, the agent also has an additional agent side data store, which is the browser's own file cache based on URL, which does persist even after the visitor navigates to a new page. Accordingly, in some embodiments the agent StyleID/CSS data store 165 is implemented as a combination of the in-memory data structure as well as the browser cache. In some embodiments, whenever the agent browser fetches a constructed stylesheet from the UCAM, the browser stores the response in its cache (as with any other GET request that the browser makes). When the agent receives a StyleID, it first checks the in-memory data structure, and then checks the browser cache to see if the CSS associated with the StyleID is locally known to the agent. Accordingly, even if the stylesheet is not found in memory, and the viewer js has to fetch it, it might be fetched from the local browser cache, without having to query the UCAM service.

In response to a determination that the StyleID is known to the agent co-browse JavaScript (a determination of YES at block 420), the agent co-browse JavaScript retrieves the CSS corresponding to the StyleID from the agent StyleID/CSS data store 165 (block 425) and creates a shadow DOM region from the shadow DOM content and applies the retrieved CSS to the created shadow DOM region (block 430). In some embodiments, the CSS is applied to the created shadow down region using the shadow root's adoptedStylesheet property.

In response to a determination that the StyleID is not known to the agent co- browse JavaScript (a determination of NO at block 420), the agent co-browse JavaScript requests the CSS corresponding to the StyleID from the UCAM (block 435). When the agent co-browse JavaScript receives the CSS from the UCAM (block 440), the agent co-browse JavaScript creates an entry in the agent StyleID/CSS data store 165 correlating the StyleID with the corresponding CSS that was received from the UCAM (block 445). This enables the agent co-browse JavaScript to maintain a copy of the CSS so that subsequently the agent co-browse JavaScript will be able to locally retrieve the corresponding CSS whenever the corresponding StyleID is received on the co-browse session. The agent co-browse JavaScript also creates a shadow DOM region from the shadow DOM content and applies the received CSS to the created shadow DOM region (block 430). In some embodiments, the CSS is applied to the created shadow down region using the shadow root's adoptedStylesheet property.

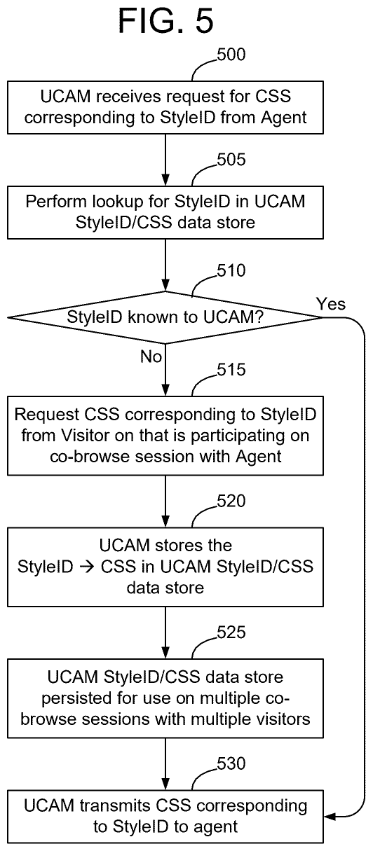

FIG. 5 is a flowchart of an example method of co-browsing adopted stylesheets showing actions taken by a Universal Co-browse Asset Management (UCAM) process on the co-browse session, according to some embodiments. As shown in FIG. 5, in some embodiments when the UCAM receives a request for CSS corresponding to a StyleID from an agent (block 500), the UCAM performs a lookup for the StyleID in the UCAM StyleID/CSS data store 155 (block 505) to determine if the StyleID is known to the UCAM (block 510).

In response to a determination that the StyleID is known to the UCAM (a determination of YES at block 510), the UCAM retrieves the CSS corresponding to the StyleID from the UCAM StyleID/CSS data store 155 and transmits the CSS corresponding to the StyleID to the agent (block 530).

In response to a determination that the StyleID is not known to the UCAM (a determination of NO at block 510), the UCAM requests the CSS corresponding to the StyleID from the visitor that is participating on the co-browse session with the agent (block 515). When the UCAM receives the CSS from the visitor, the UCAM creates an entry in the UCAM StyleID/CSS data store 155 correlating the StyleID with the received CSS (block 520). This enables the UCAM to maintain a copy of the CSS so that subsequently the UCAM will be able to locally retrieve CSS whenever the UCAM receives a request for the CSS associated with the StyleID from this agent or from other agents that are on co-browse sessions with visitors to the website. Specifically, in some embodiments the UCAM StyleID/CSS data store 155 is persisted at the UCAM for use on multiple co-browse sessions with multiple visitors (block 525) to minimize the number of times the UCAM is required to request CSS corresponding to StyleIDs across co-browse sessions. The CAM also transmits the CSS corresponding to the StyleID to the agent (block 530).

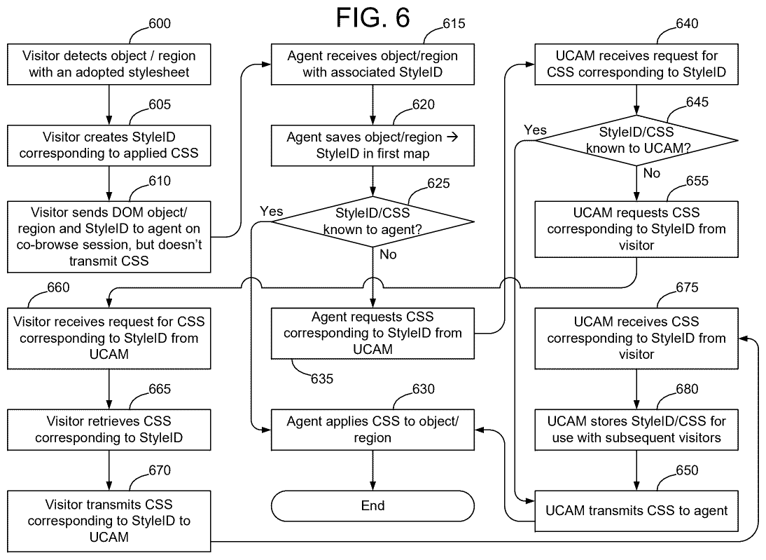

FIG. 6 is a flowchart of an example method of co-browsing adopted stylesheets showing interactions between the visitor, UCAM, and Agent, according to some embodiments. As shown in FIG. 6, in some embodiments when a visitor detects a object or region with an adopted stylesheet (block 600), the visitor creates a StyleID associated with the corresponding object/region, for example by hashing the CSS associated with the adopted stylesheet (block 605). Then, when the visitor transmits the DOM object/region on the co-browse session, rather than transmitting the actual CSS associated with the adopted stylesheet, the visitor instead transmits the StyleID along with the corresponding DOM of the object/region (block 610).

The agent receives the object/region with the associated StyleID (block 615) and saves the object/region to StyleID in a first map (block 620). The agent also performs a lookup in an agent StyleID/CSS data store 165 to determine if the StyleID/CSS correspondence is known to the agent (block 625). In response to a determination that the agent knows the CSS associated with the StyleID (a determination of YES at block 625), the agent JavaScript applies the CSS associated with the adopted stylesheet to the object/region (block 630). This enables the CSS to be applied by the agent without requiring the CSS to be sent by the visitor on the co-browse session in connection with transmission of the DOM of the object/region.

In response to a determination that the agent does not know the CSS associated with the StyleID (a determination of NO at block 625), the agent co-browse JavaScript requests the CSS corresponding to the StyleID from the UCAM (block 635). The UCAM receives the request for the CSS corresponding to the StyleID (block 640) and performs a lookup in a UCAM StyleID/CSS data store 155 to determine if the StyleID/CSS correspondence is known to the UCAM (block 645).

In response to a determination that the UCAM knows the CSS associated with the StyleID (a determination of YES at block 645), the UCAM transmits the requested CSS associated with the StyleID to the agent (block 650). The agent JavaScript then applies the received CSS associated with the adopted stylesheet to the object/region (block 630). This enables the CSS to be applied by the agent without requiring the visitor to transmit the CSS on the co-browse session in connection with transmission of the DOM object/region. The agent co-browse JavaScript also stores a copy of the CSS associated with the StyleID in the agent StyleID/CSS data store 165.

In response to a determination that the UCAM does not know the CSS associated with the StyleID (a determination of NO at block 345), the UCAM requests the CSS corresponding to the StyleID from the Visitor (block 655). The visitor receives the request for the CSS corresponding to a particular StyleID from the UCAM (block 660). The visitor retrieves the CSS corresponding to the StyleID from a visitor StyleID/CSS data store 165 (block 665), and the visitor transmits the CSS corresponding to the StyleID to the UCAM (block 670).

The UCAM receives the CSS corresponding to the StyleID from the visitor (block 675), the UCAM stores the StyleID/CSS in the UCAM StyleID/CSS data store 155 (block 680), and the UCAM transmits the requested CSS associated with the StyleID to the agent (block 650). The agent JavaScript then applies the received CSS associated with the adopted stylesheet to the object/region (block 630). The agent co-browse JavaScript also stores a copy of the CSS associated with the StyleID in the agent StyleID/CSS data store 165.

As shown in FIG. 6, by causing the visitor to create and transmit StyleID from CSS of adopted stylesheets, it is possible to greatly reduce the amount of CSS that is transmitted on co-browse sessions. In instances where a given instance of a UCAM is being used to support multiple co-browse sessions with multiple visitors, only one of the visitors will be requested to provide a copy of the CSS associated with a given StyleID to the UCAM, after which point the UCAM will have a stored copy of the CSS associated with the corresponding StyleID. Each agent will request the CSS associated with a given StyleID from the UCAM once during each co-browse session, after which point the agent co-browse JavaScript will have a stored copy of the CSS associated with the corresponding StyleID. Optionally, the agent StyleID/CSS data store 165 may be persisted for use between co-browse sessions to minimize the number of instances that the agent is required to request CSS corresponding to StyleIDs from the UCAM.

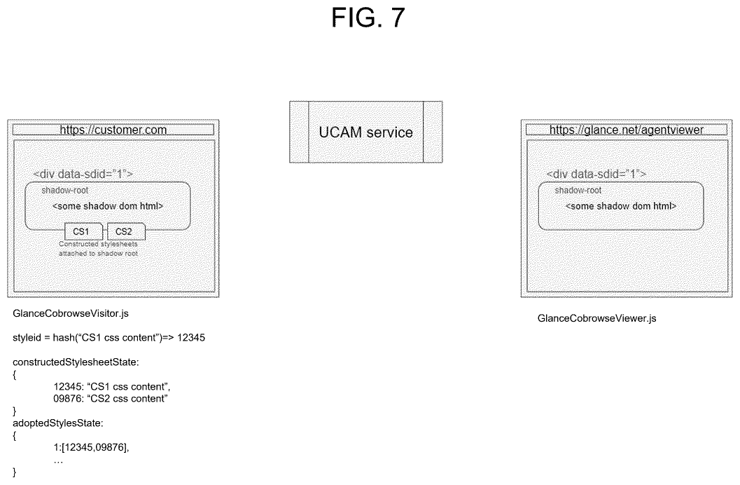

FIGS. 7-12 are diagrams showing interaction between the network of components of FIG. 1 to optimize the manner in which adopted stylesheets are handled on co-browse session and between co-browse sessions. As shown in FIG. 7, in some embodiments, browser caching as well as the UCAM data store are used to manage adopted stylesheets, such that the adopted stylesheets are not required to be constantly sent on the co-browse session from the visitor to the agent during the co-browse session. For example, as shown in FIG. 7, in some embodiments, when the visitor detects an adopted stylesheet on the visitor's page (attached to an element with a shadowRoot that is tracked by the visitor co-browse JavaScript 145), the visitor co-browse JavaScript creates a unique ID for the adopted stylesheet by taking a hash of the whole CSS rules string of the stylesheet. The visitor then stores the hash (StyleID) in a map of shadow host id (Sdid) to list of StyleIDs, and also in a map of StyleIDs to CSS.

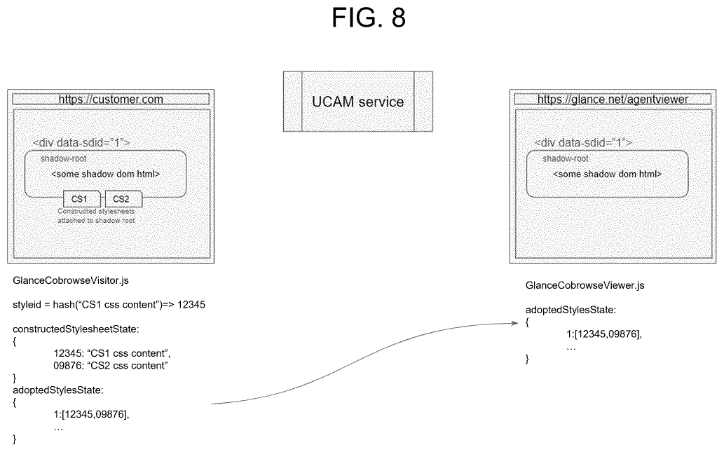

As shown in FIG. 8, the visitor sends to the agent a new map of sdids to StyleIDs (hash values). Accordingly, when the agent receives a shadow DOM element identified by a sdid, the agent is able to use the map of sdids to StyleIDs to determine what adopted stylesheet should be applied to the shadow DOM element.

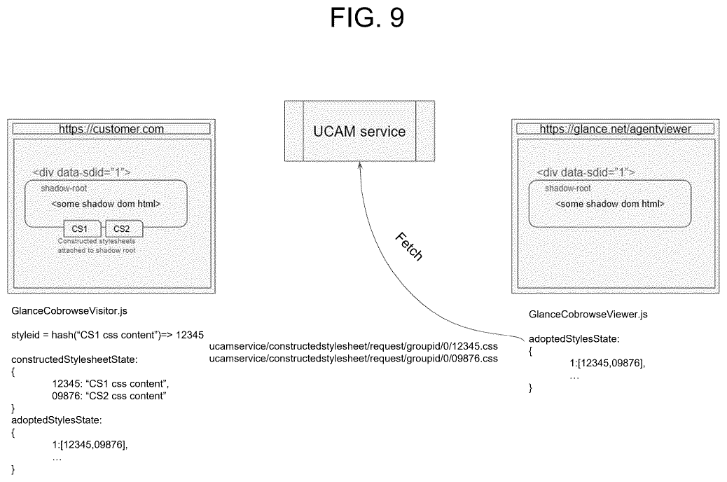

As shown in FIG. 9, when the agent side reconstructs the DOM, if the agent does not already have a locally stored copy of the adopted stylesheet corresponding to one or more of the StyleIDs, the Agent co-browse javascript sends a request containing the hash value (StyleID) to the UCAM to request the adopted stylesheet from the UCAM. The hash value identifying the adopted stylesheet might be associated with a particular shadow root, or might be associated with the entire document depending on how the adopted stylesheet is applied. In some embodiments, the visitor processes the URLs in CSS content to point to the UCAM so that the agent can acquire the resources identified in the stylesheets (for example, images or fonts) from the UCAM rather than the website.

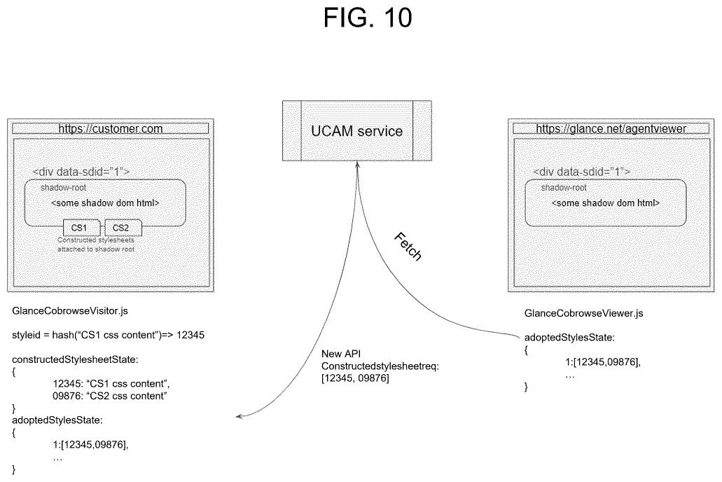

As shown in FIG. 10, when the UCAM service receives a request for an adopted stylesheet, it determines whether it previously has a cached copy of the adopted stylesheet by comparing the hash value against a table of known adopted stylesheets, shown in FIG. 1 as StyleID/CSS data store 155. In response to a determination that the UCAM does not have a cached copy of the adopted stylesheet, the UCAM sends a request to the visitor co-browse JavaScript 145 to request the visitor to send the adopted stylesheet to the UCAM. The request includes the unique ID (StyleID) for the stylesheet (the hash value).

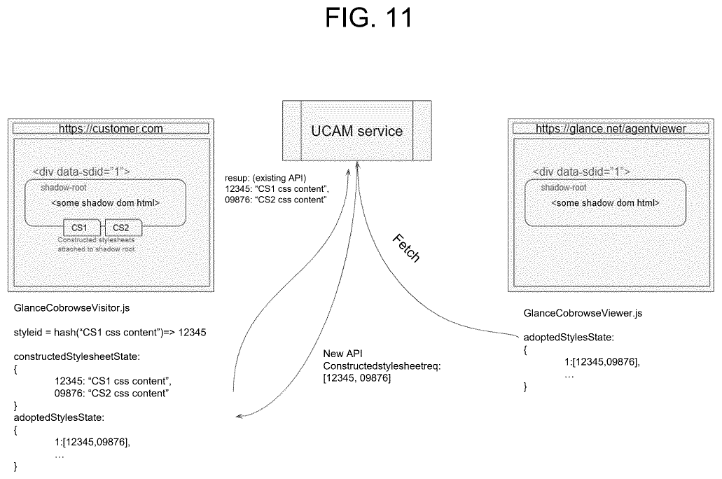

As shown in FIG. 11, the visitor receives a message containing a request for the adopted stylesheet with the unique id for the stylesheet. In response, the visitor co- browse JavaScript 145 checks its shadow DOM state for that stylesheet ID, and uploads a copy of the adopted stylesheet to UCAM using a resource upload message. While this requires the visitor to transmit the actual CSS of the adopted stylesheet, the visitor only needs to do this once, since the UCAM will keep a local copy of the CSS in the StyleID/CSS data store 155 and, subsequently, will be able to directly transmit CSS to agents when requested.

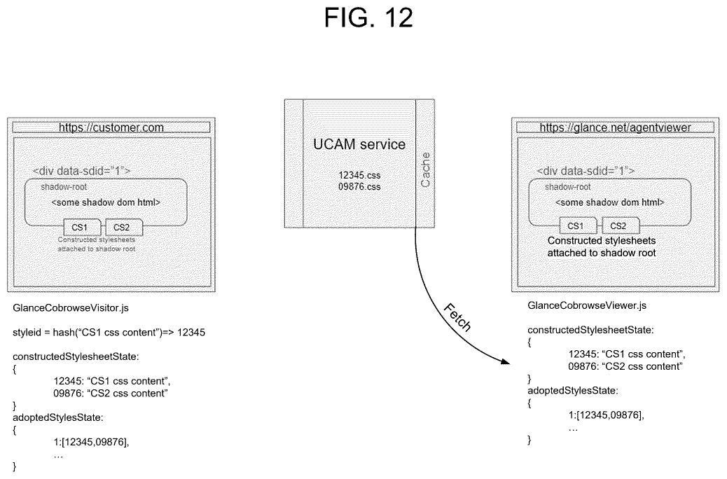

As shown in FIG. 12, upon receipt, the UCAM returns the stylesheet to the agent. In some embodiments, the UCAM stores the adopted stylesheet in the StyleID/CSS data store 155 and, in the event that the agent or a different agent subsequently requests the same adopted stylesheet, the UCAM is able to provide the adopted stylesheet to the agent, thus skipping FIGS. 10 and 11 in connection with subsequent requests for cached adopted stylesheets. In some embodiments, stylesheets in the UCAM are able to be reused between different co-browse sessions, pages, and agents. By enabling the UCAM to persist CSS associated with StyleIDs, it is possible to greatly reduce the amount of CSS that the visitors need to transmit when participating in multiple co-browse sessions. By causing the visitor co-browse JavaScript of multiple visitors to use the same hash function to create StyleIDs when co-browsing shadow DOM elements of a given web page, each of the visitors will independently create and transmit the same StyleID for a given combination of CSS elements. Accordingly, only one visitor will need to transmit the actual CSS associated with a given set of CSS elements to the UCAM, and then once the UCAM has the CSS corresponding to a given StyleID, the UCAM will be able to provide the corresponding CSS to requesting agents without requiring subsequent visitors to transmit the CSS elements to the UCAM on the subsequent co-browse sessions.

The methods described herein may be implemented as software configured to be executed in control logic such as contained in a CPU of an electronic device such as a computer. The functions described herein may be implemented as sets of program instructions that are stored in a non-transitory tangible computer readable medium. When implemented in this manner, the computer program includes a set of instructions which, when executed by a computer, cause the computer to perform a method to implement the functions described above. Programmable logic can be fixed temporarily or permanently in a non-transitory tangible computer readable medium such as a read-only memory chip, a computer memory, a disk, or other storage medium. In addition to being implemented in software, the logic described herein can be embodied using discrete components, integrated circuitry, programmable logic used in conjunction with a programmable logic device such as a Field Programmable Gate Array (FPGA) or microprocessor, or any other device including any combination thereof. All such embodiments are intended to fall within the scope of the present invention.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed is:

1. A method of optimizing co-browsing of webpages containing shadow DOM regions with adopted stylesheets, comprising:
establishing a co-browse session between a first participant computer and a second participant computer in which a Document Object Model (DOM) of a first browser at the first participant computer is transmitted to the second participant computer, and used at the second participant computer to recreate a content of the first browser at a second browser, the DOM including a plurality of DOM elements;
identifying a DOM element by the first participant computer that has an adopted stylesheet, the adopted stylesheet including a corresponding set of Cascading Style Sheets (CSS) content;
creating a StyleID to uniquely identify the complete set of CSS content corresponding to the adopted stylesheet;
forwarding the DOM element and the StyleID on the co-browse session by the first participant computer, without forwarding the set of CSS content corresponding to the adopted stylesheet;
receiving a request, by the first participant computer, for the set of CSS content; and
only in response to receiving the request for the set of CSS content, transmitting by the first participant computer the set of CSS content on the co-browse session.

2. The method of claim 1, wherein creating the StyleID by the first participant computer comprises applying a hash function to the complete set of the CSS parameters corresponding to the adopted stylesheet.

3. The method of claim 1, further comprising storing the StyleID and the set CSS content by the first participant computer.

4. The method of claim 1, after transmitting, by the first participant computer, the set of one or more CSS content, storing the StyleID and the set of CSS content by a server facilitating the co-browse session.

5. The method of claim 4, wherein the server facilitating the co-browse session is configured to respond to requests for sets of CSS content corresponding to StyleIDs sent by the second participant computer.

6. The method of claim 4, wherein the server facilitating the co-browse session is configured to store StyleID and corresponding CSS from multiple co-browse sessions and respond to requests for sets of CSS content corresponding to StyleIDs from the second participant computer on the co-browse session that were learned on the multiple co-browse sessions.

7. The method of claim 1, further comprising storing the StyleID and the set of CSS content by the second participant computer.

8. The method of claim 7, further comprising receiving the StyleID by the second participant computer on the co-browse session;
determining by the second participant computer that the set of CSS content corresponding to the StyleID is known by the second participant computer; and
locally applying the CSS content to the DOM element by the second participant computer without requesting transmission of the corresponding set of CSS content on the co-browse session.

9. A system for optimizing co-browsing of webpages containing shadow DOM regions with adopted stylesheets, comprising:
one or more processors and one or more storage devices storing instructions that are operable, when executed by the one or more processors, to cause the one or more processors to perform operations comprising:
establishing a co-browse session between a first participant computer and a second participant computer in which a Document Object Model (DOM) of a first browser at the first participant computer is transmitted to the second participant computer, and used at the second participant computer to recreate a content of the first browser at a second browser, the DOM including a plurality of DOM elements;
identifying a DOM element by the first participant computer that has an adopted stylesheet, the adopted stylesheet including a corresponding set of Cascading Style Sheets (CSS) content;
creating a StyleID to uniquely identify the complete set of CSS content corresponding to the adopted stylesheet;
forwarding the DOM element and the StyleID on the co-browse session by the first participant computer, without forwarding the set of CSS content corresponding to the adopted stylesheet;
receiving a request, by the first participant computer, for the set of CSS content; and
only in response to receiving the request for the set of CSS content, transmitting by the first participant computer the set of CSS content on the co-browse session.

10. The system of claim 9, wherein creating the StyleID by the first participant computer comprises applying a hash function to the complete set of the CSS parameters corresponding to the adopted stylesheet.

11. The system of claim 9, further comprising storing the StyleID and the set CSS content by the first participant computer.

12. The system of claim 9, after transmitting, by the first participant computer, the set of one or more CSS content, storing the StyleID and the set of CSS content by a server facilitating the co-browse session.

13. The system of claim 12, wherein the server facilitating the co-browse session is configured to respond to requests for sets of CSS content corresponding to StyleIDs sent by the second participant computer.

14. The system of claim 12, wherein the server facilitating the co-browse session is configured to store StyleID and corresponding CSS from multiple co-browse sessions and respond to requests for sets of CSS content corresponding to StyleIDs from the second participant computer on the co-browse session that were learned on the multiple co-browse sessions.

15. The system of claim 9, further comprising storing the StyleID and the set of CSS content by the second participant computer.

16. The system of claim 15, further comprising receiving the StyleID by the second participant computer on the co-browse session;
determining by the second participant computer that the set of CSS content corresponding to the StyleID is known by the second participant computer; and
locally applying the CSS content to the DOM element by the second participant computer without requesting transmission of the corresponding set of CSS content on the co-browse session.
